(19) United States
(12) Patent Application Publication
(10) Pub. No.: US 2021/0179041 A1
(43) Pub. Date: Jun. 17, 2021

(54) METHOD FOR DETECTING A LEAK IN A DRIVE-BY-WIRE BRAKE SYSTEM

(71) Applicant: Continental Automotive Systems Inc., Auburn Hills, MI (US)

(72) Inventor: Eric Alan Matoy, Leonard, MI (US)

(21) Appl. No.: 16/712,375

(22) Filed: Dec. 12, 2019

(51) Int. Cl. B60T 8/1761; B60T 8/88; F15B 20/00

(52) U.S. Cl. CPC B60T 8/1761; B60T 8/88; B60T 2240/00; B60T 2270/404; F15B 20/005

(57) ABSTRACT

A method of detecting a leak in a brake-by-wire hydraulic brake system includes determining if the brake system is in an ABS cycle and determining a pressure medium volume delivered for a measured brake pressure when the brake system is in the ABS cycle. The pressure medium volume is compared with a model value for the brake system at the measured brake pressure. Wheel slip of at least one wheel is identified when a difference between the pressure medium volume and the model value exceeds a specified threshold. At least one brake is isolated corresponding to the at least one wheel without wheel slip.

### BACKGROUND

The present disclosure relates to a method for detecting a leak in a drive-by-wire brake system for a vehicle.

Two-axle vehicles are fitted with hydraulic systems that have two brake circuits, thus ensuring that, if one of the two brake circuits fails, the vehicle can still be braked by the other brake circuit. In general, the wheel brakes are associated with the brake circuits in a diagonally split arrangement, in which a brake circuit acts on one front wheel and the respective diagonally opposite rear wheel, or in a front/rear split. The two brake circuits are connected to a master brake cylinder A brake pedal is coupled to the master brake cylinder and is actuated by a driver to build up a corresponding brake pressure in the two brake circuits.

### SUMMARY

In one exemplary embodiment, a method of detecting a leak in a brake-by-wire hydraulic brake system includes determining if the brake system is in an ABS cycle and determining a pressure medium volume delivered for a measured brake pressure when the brake system is in the ABS cycle. The pressure medium volume is compared with a model value for the brake system at the measured brake pressure. Wheel slip of at least one wheel is identified when a difference between the pressure medium volume and the model value exceeds a specified threshold. At least one brake is isolated corresponding to the at least one wheel without wheel slip.

In a further embodiment of any of the above, the least one isolated brake includes closing an inlet valve to the at least one brake.

In a further embodiment of any of the above, the at least one brake includes a first brake and a second brake each corresponding to a first wheel and a second wheel of the at least one wheel without wheel slip. The first brake and the second brake are isolated from the brake system.

In a further embodiment of any of the above, the brake system includes a first brake circuit and a second brake circuit. The first brake is located in the first brake circuit and the second brake is located in the second brake circuit.

In a further embodiment of any of the above, the brake system includes a first brake circuit that has a pair of first brakes. A second brake circuit that has a pair of second brakes.

In a further embodiment of any of the above, the first brake circuit includes one of a pair of first inlet valves upstream of the each of the pair of first brakes.

In a further embodiment of any of the above, each of the pair of first brakes is located fluidly between one of the pair of first inlet valves and one of a pair of first outlet valves.

In a further embodiment of any of the above, the second brake circuit includes one of a pair of second inlet valves upstream of each of the pair of second brakes.

In a further embodiment of any of the above, each of the pair of second brakes is located fluidly between one of the pair of second inlet valves and one of a pair of second outlet valves.

In a further embodiment of any of the above, the brake system includes an electrically controllable pressure source that is in fluid communication with the first brake circuit and the second brake circuit.

In a further embodiment of any of the above, identifying wheel slip of the at least one wheel includes identifying the wheel slip with a wheel speed sensor.

In a further embodiment of any of the above, wheel slip indicates the at least one wheel has entered at least one of a locked or a sliding condition.

In another exemplary embodiment, a brake-by-wire hydraulic brake system for a vehicle includes a first brake circuit with a pair of first brakes, a second brake circuit with a pair of second brakes, and an electrically controllable pressure source is in fluid communication with the first brake circuit and the second brake circuit. A controller is configured to determine if the brake system is in an ABS cycle and determining a pressure medium volume delivered for a measured brake pressure when the brake system is in the ABS cycle. The pressure medium volume is compared with a model value for the brake system at the measured brake pressure. Wheel slip of at least one wheel is identified when a difference between the pressure medium volume and the model value exceeds a specified threshold. At least one brake of the pair of first brakes or the pair of second brakes that corresponds to the at least one wheel without wheel slip is isolated.

In a further embodiment of any of the above, the isolation of at least one of the pair of first brakes or the pair of second brakes includes closing an inlet valve to the one of the pair of first brakes or the pair of second brakes.

In a further embodiment of any of the above, the first brake circuit includes one of a pair of first inlet valves upstream of the each of the pair of first brakes.

In a further embodiment of any of the above, each of the pair of first brakes is located fluidly between one of the pair of first inlet valves and one of a pair of first outlet valves.

In a further embodiment of any of the above, the second brake circuit includes one of a pair of second inlet valves upstream of each of the pair of second brakes.

In a further embodiment of any of the above, each of the pair of second brakes is located fluidly between one of the pair of second inlet valves and one of a pair of second outlet valves.

In a further embodiment of any of the above, identifying wheel slip of the at least one wheel includes identifying the wheel slip with a wheel speed sensor.

In a further embodiment of any of the above, wheel slip indicates the at least one wheel has entered at least one of a locked or a sliding condition.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 schematically illustrates a brake-by-wire brake system.

FIG. 2 illustrates a method of detecting a leak in the brake-by-wire brake system of FIG. 1.

### DETAILED DESCRIPTION

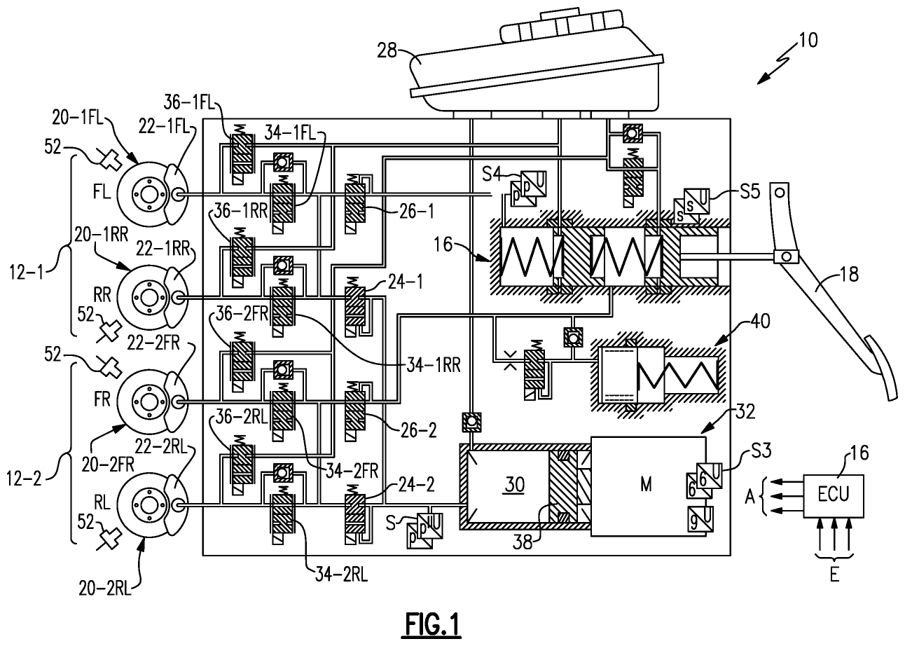

FIG. 1 illustrates an example “brake-by-wire” hydraulic brake system 10 on a vehicle having a first brake circuit 12-1 and a second brake circuit 12-2. A brake control unit 14 generates control signals for the valves of the first and second brake circuits 12-1 and 12-2 as output signals A on the basis of sensor signals E as input signals.

The brake system 10 includes a master cylinder 16 that can be actuated by a brake pedal 18 and a pressure medium reservoir 28 that is connected to the master cylinder 16. An electrically controllable pressure source 30 includes an electrohydraulic actuator with an electric motor 32 as a drive motor and provides pressurized fluid to the first brake circuit 12-1 and the second brake circuit 12-2 through a first circuit block valve 24-1 and a second circuit block valve 24-2, respectively.

The first brake circuit 12-1 is in fluid communication with a front left-hand wheel brake 22-1FL and a rear right-hand wheel brake 22-1RR for a front left-hand wheel 20-1FL and a rear right-hand wheel 20-1RR, respectively, through respective hydraulic lines. The first brake circuit 12-1 also includes an inlet valve 34-1FL and an outlet valve 36-1FL that forms a pressure modulation device for the front left-hand wheel brake 22-1FL. Additionally, the first brake circuit 12-1 also includes an inlet valve 34-1RR and an outlet valve 36-1RR that forms a pressure modulation device for the rear right-hand wheel brake 20-1RR.

The second brake circuit 12-2 is in fluid communication with a front right-hand wheel brake 22-2FR and rear left-hand wheel brake 22-2RL for a front right-hand wheel 20-2FR and a rear left-hand wheel 20-2RL, respectively, through respective hydraulic lines. The second brake circuit 12-2 also includes an inlet valve 34-2FR and an outlet valve 36-2FR that forms a pressure modulation device for the front right-hand wheel brake 22-2FR. Additionally, the second circuit also includes an inlet valve 34-2RL and an outlet valve 36-2RL that forms a pressure modulation device for the rear left-hand wheel brake 22-2RL.

To detect a rotational behavior of the wheels 20-1FL, 20-1RR, 20-2FR, and 20-2RL, there are respective speed sensors S2, which feed their sensor signals to the control unit 14 for evaluation to enable a corresponding slip control operation to be carried out at the wheels 20-1FL, 20-1RR, 20-2FR, and 20-2RL.

In a “brake-by-wire” operating mode, the inlet valves 34-1FL and 34-1RR are connected to a first circuit block valve 24-2 and inlet valves 34-2FR and 34-2RL are connected to a second circuit block valve 24-2. Each of the first and second circuit block valves 24-1 and 24-2 are in fluid communication with the electrically controllable pressure source 30 for generating a system pressure. To measure the system pressure generated by the electrically controllable pressure source 30, a pressure sensor S is arranged on the high-pressure side thereof. Furthermore, each of the outlet valves 36-1FL, 36-1RR, 36-2FR, and 36-2RL are connected to the pressure medium reservoir 28 and are in a normally closed position as opposed to the inlet valves 34-1FL, 34-1RR, 34-2FR, and 34-2RL, which are in a normally open position.

In the illustrated example, the master cylinder 16 is a dual-circuit tandem master cylinder and is connected to the pressure medium reservoir 28. To form a redundant braking approach for the “brake-by-wire” brake system 10, the master cylinder 16 can be connected to the wheel brakes 22-1FL and 22-1RR of the first brake circuit 12-1 via a first block valve 26-1 and to the wheel brakes 22-2FR and 22-2RL of the second brake circuit 12-2 via a second block valve 26-1. The brake pressure generated in this case is measured with a pressure sensor S4. With the first and second block valves 26-1 and 26-2, the hydraulic connection between the master cylinder 16 and the first and second brake circuit 12-1 and 12-2 is divided in the “brake-by-wire” operating mode.

During the brake-by-wire operating mode, a displacement sensor S5 measures a pedal actuation of the brake pedal 18 brought about by the driver to determine a braking demand of the driver. A displacement simulator 40 is coupled hydraulically to the master brake cylinder 5 and receives the braking demand measure by the sensor S5 and simulates a haptic feedback corresponding to the brake pressure generated, i.e. a corresponding pedal feel, to the brake pedal 18.

In the illustrated example, the electrically controllable pressure source 30 is a single-circuit electrohydraulic actuator with a piston 38 actuated by the electric motor 32 via a rotation/translation mechanism. The piston 38 delimits a pressure space, which is connected to the pressure medium reservoir 28 in order to draw in the pressure medium. The position of the piston 38 is determined from the rotor position of the electric motor 32, which is determined by a rotor position sensor S3, thus allowing the pressure medium volume delivered to be determined from the position of the piston 38.

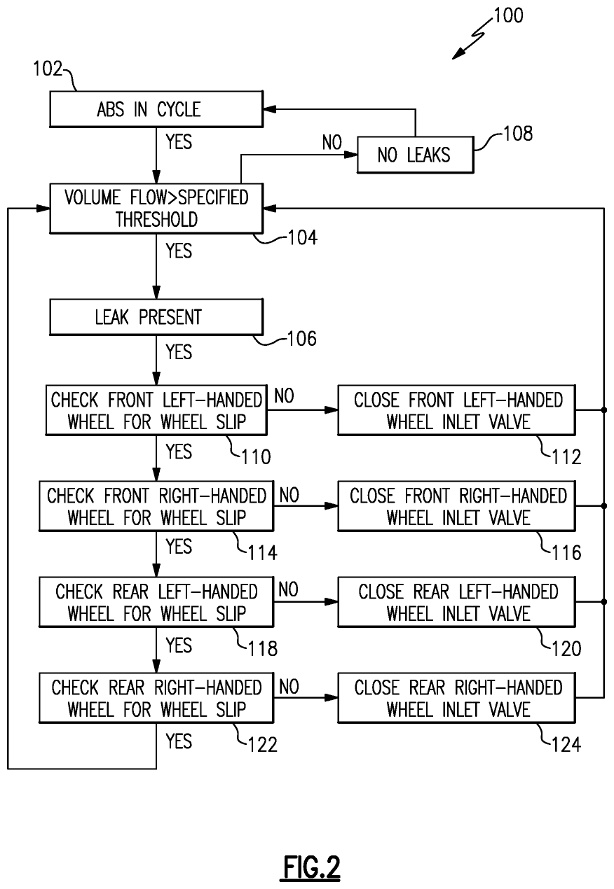

FIG. 2 illustrates a method 100 of detecting a leak in the brake system 10. A leak during the “brake-by-wire” operating mode is detected by using the pressure sensor S to measure the brake pressure generated during a braking operation, e.g. an ABS control operation (Item 102). With the first and second circuit block valves 24-1 and 24-2 open, a pressure medium volume delivered for this brake pressure can be determined with a sensor S. Depending on the brake pressure, a model value for the pressure medium volume at the delivered brake pressure is determined by the control unit 14 with the model value indicating a theoretically correct value of the pressure medium volume required to build up the pressure value detected. The pressure medium volume determined by the rotor position sensor S3 is compared with this model value. If the difference between the pressure medium volume determined and the model value (Item 104) thereof exceeds a specified threshold (Item 106), the presence of a leak in the brake system 10 is assumed, and if it does not exceed the specified threshold (Item 108), the brake system 10 does not have leak.

When a leak has been detected during the ABS control operation, the control unit 14 can then identify the specific wheel 20-1FL, 20-1RR, 20-2FR, 20-2RL associated with the leak. To identify the specific wheel 20-1FL, 20-1RR, 20-2FR, 20-2RL, the control unit 14 will look to the respective speed sensors S2 for each wheel to determine if there is wheel slip. When the speed sensors S2 have identified wheel slip, the corresponding wheel 20-1FL, 20-1RR, 20-2FR, 20-2RL has entered a locked and/or a sliding condition. When one of the wheels 20-1FL, 20-1RR, 20-2FR, 20-2RL has experienced wheel slip, it indicates that the corresponding brake 22-1FL, 22-1RR, 22-2FR, 22-2RL is able to provide sufficient pressure such that a leak associated with that wheel 20-1FL, 20-1RR, 20-2FR, 20-2RL is unlikely.

In the illustrated example, the control unit 14 will check for wheel slip of the front left-handed wheel 20-1FL with the respective wheel speed sensor S2 (Item 110). If the information conveyed to the control unit 14 from the respective wheel speed sensor S2 indicates that there is not wheel slip at the front left-handed wheel 20-1FL, the control unit 14 will signal the inlet valve 34-1FL to close (Item 112). The control unit 14 will then return to item 104 and continue to compare the difference between the pressure medium volume determined and the model value to identify the presence of a leak as discussed above.

If the control unit determined that there was wheel slip at the front left-handed wheel 20-1FL, the control unit 14 will check for wheel slip of the front right-handed wheel 20-2FR with the respective wheel speed sensor S2 (Item 114). If the information conveyed to the control unit 14 from the respective wheel speed sensor S2 indicates that there is not wheel slip at the front right-handed wheel 20-2FR, the control unit 14 will signal the inlet valve 34-2FR to close (Item 116). The control unit 14 will then return to item 104 and continue to compare the difference between the pressure medium volume determined and the model value to identify the presence of a leak as discussed above.

If the control unit determined that there was wheel slip at the front right-handed wheel 20-2FR, the control unit 14 will check for wheel slip of the rear left-handed wheel 20-2RL with the respective wheel speed sensor S2 (Item 118). If the information conveyed to the control unit 14 from the respective wheel speed sensor S2 indicates that there is not wheel slip at the rear left-handed wheel 20-2RL, the control unit 14 will signal the inlet valve 34-2RL to close (Item 120). The control unit 14 will then return to item 104 and continue to compare the difference between the pressure medium volume determined and the model value to identify the presence of a leak as discussed above.

If the control unit determined that there was wheel slip at the rear left-handed wheel 20-2RL, the control unit 14 will check for wheel slip of the rear right-handed wheel 20-1RR with the respective wheel speed sensor S2 (Item 122). If the information conveyed to the control unit 14 from the respective wheel speed sensor S2 indicates that there is not wheel slip at the rear right-handed wheel 20-1RR, the control unit 14 will signal the inlet valve 34-1RR to close (Item 120). The control unit 14 will then return to item 104 and continue to compare the difference between the pressure medium volume determined and the model value to identify the presence of a leak as discussed above.

Although the illustrated example method 100 provides a specific order of wheels for checking wheel slip, the control unit 14 can check the wheels in a different order, such as by the wheels in each of the first and second brake circuit 12-1 or 12-2. One feature of the above method is to maintain the greatest amount of braking power when a leak is determined and to prevent further loss of fluid from the brake system 10.

For example, if a leak is identified at a single wheel 20-1 or 20-2, only that single wheel would be isolated from the remaining brake system 10 such that there would be one remaining wheel from one of the first and second brake circuit 12-1, 12-2 functioning and both wheels 20-1 or 20-2 from the other of the first and second brake circuits 12-1, 12-2. Additionally, if a leak was identified at a single wheel 20-1, 20-2 in the first and second brake circuits 12-1, 12-2, respectively, then the other of the wheel 20-1, 20-2 in the first and second brake circuits 12-1, 12-2 would still be able to provide braking for the vehicle.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method of detecting a leak in a brake-by-wire hydraulic brake system, the method comprising:
determining if the brake system is in an ABS cycle;
determining a pressure medium volume delivered for a measured brake pressure when the brake system is in the ABS cycle;
comparing the pressure medium volume with a model value for the brake system at the measured brake pressure;
identifying wheel slip of at least one wheel when a difference between the pressure medium volume and the model value exceeds a specified threshold; and
isolating at least one brake corresponding to the at least one wheel without wheel slip.

2. The method of claim 1, wherein isolating the least one brake includes closing an inlet valve to the at least one brake.

3. The method of claim 1, wherein the at least one brake includes a first brake and a second brake each corresponding to a first wheel and a second wheel of the at least one wheel without wheel slip and isolating the first brake and the second brake from the brake system.

4. The method of claim 3, wherein the brake system includes a first brake circuit and a second brake circuit and the first brake is located in the first brake circuit and the second brake is located in the second brake circuit.

5. The method of claim 1, wherein the brake system includes a first brake circuit having a pair of first brakes and a second brake circuit having a pair of second brakes.

6. The method of claim 5, wherein the first brake circuit includes a pair of first inlet valves upstream of the each of the pair of first brakes.

7. The method of claim 6, wherein each of the pair of first brakes is located fluidly between one of the pair of first inlet valves and one of a pair of first outlet valves and isolating one of the first pair of brake includes closing a corresponding one of the pair of first inlet valves.

8. The method of claim 6, wherein the second brake circuit includes a pair of second inlet valves upstream of each of the pair of second brakes.

9. The method of claim 8, wherein each of the pair of second brakes is located fluidly between one of the pair of second inlet valves and one of a pair of second outlet valves and isolating one of the second pair of brakes includes closing a corresponding one of the second pair of inlet valves.

10. The method of claim 5, wherein the brake system includes an electrically controllable pressure source in fluid communication with the first brake circuit and the second brake circuit.

11. The method of claim 1, wherein identifying wheel slip of the at least one wheel includes identifying the wheel slip with a wheel speed sensor.

12. The method of claim 11, wherein wheel slip indicates the at least one wheel has entered at least one of a locked or a sliding condition.

13. A brake-by-wire hydraulic brake system for a vehicle comprising:
a first brake circuit having a pair of first brakes;
a second brake circuit having a pair of second brakes;
an electrically controllable pressure source in fluid communication with the first brake circuit and the second brake circuit; and
a controller configured to perform the following operations:
determining if the brake system is in an ABS cycle;
determining a pressure medium volume delivered for a measured brake pressure when the brake system is in the ABS cycle;
comparing the pressure medium volume with a model value for the brake system at the measured brake pressure;
identifying wheel slip of at least one wheel when a difference between the pressure medium volume and the model value exceeds a specified threshold; and
isolating at least one brake of the pair of first brakes or the pair of second brakes that corresponds to the at least one wheel without wheel slip.

14. The system of claim 13, wherein isolating at least one of the pair of first brakes or the pair of second brakes includes closing an inlet valve to the one of the pair of first brakes or the pair of second brakes.

15. The system of claim 14, wherein the first brake circuit includes one of a pair of first inlet valves upstream of the each of the pair of first brakes.

16. The system of claim 15, wherein each of the pair of first brakes is fluidly connected to one of the pair of first inlet valves and one of a pair of first outlet valves.

17. The system of claim 16, wherein the second brake circuit includes one of a pair of second inlet valves upstream of each of the pair of second brakes.

18. The system of claim 17, wherein each of the pair of second brakes is fluidly connected to one of the pair of second inlet valves and one of a pair of second outlet valves.

19. The system of claim 13, wherein identifying wheel slip of the at least one wheel includes identifying the wheel slip with a wheel speed sensor.

20. The system of claim 19, wherein wheel slip indicates the at least one wheel has entered a slip condition to be controlled by the ABS cycle.
